(19) United States
(12) Patent Application Publication
(10) Pub. No.: US 2014/0295140 A1
(43) Pub. Date: Oct. 2, 2014

(54) Friction Surface

(71) Applicant: Charles Edmund King, Kidlington (GB)

(72) Inventors: Charles Edmund King, Oxford (GB); Julian David Williams, London (GB)

(21) Appl. No.: 14/222,658

(22) Filed: Mar. 23, 2014

(30) Foreign Application Priority Data
Mar. 26, 2013 (GB) 1305534.8
Mar. 18, 2014 (GB) 1404872.2

(51) Int. Cl. A43B 13/02; A43B 13/10; A63B 22/18; A63F 13/20; C08F 236/12; C08F 110/02

(52) U.S. Cl. CPC A43B 13/02; C08F 236/12; C08F 110/02; A63B 22/18; A63F 13/06; A43B 13/026; A43B 13/10
USPC 428/156; 36/103

(57) ABSTRACT

According to the present invention there is provided a polymer friction surface subject to sliding contact with footware worn by a user wherein said friction surface is embossed and said footware having hard, gloss interface with said friction surface.

### CROSS REFERENCE TO RELATED APPLICATIONS

This application claims priority from UK Application No. GB1305534.8 filed on Mar. 26, 2013, amendments filed on Dec. 9, 2013 (an Application No for the December filing is being requested) and UK Application No. GB1404872.2 filed on Mar, 18, 2014 all incorporated by reference in their entirely for all purposes.

### BACKGROUND

Improvements in computer based virtual reality (VR) and Head Mounted Displays (HMD) offers the potential for users to become immersed in a VR world. A satisfactory level of immersion can be achieved for seated situations such as driving or flying by moving through VR scenarios using hand operated devices, e.g. keyboards, steering wheel, joystick or mouse, however when seated the level of immersion is reduced if in a VR world a user is required to walk or run.

To date there has been little or no opportunity for the general public to have access to omni-direction treadmills that enable on the spot walking, because these machines have largely been developed for military and research organisations and are typically large and expensive.

A walk simulation device for exercise and virtual reality immersion U.S. Pat. No. 7,470,218 teaches an omni-directional treadmill using a low friction dish material combined with low friction footwear.

Thus U.S. Pat. No. 7,470,218 describes portable locomotion platform device, in embodiments lacking handles or anything for a user to grab onto with hands. The locomotion platform device permits a user to walk, or run, crouch, jump or change direction, and continue these motions without impediment, while remaining substantially constrained to the area of the device. Preferably the user does not move substantially away from a center of the platform as the user moves their feet. Optionally a brace is provided, connected to and surrounding an underside surface of the platform in order to prevent movement of the platform during use.

In some preferred embodiments the device comprises a platform with an upward facing surface, in embodiments an essentially spherically concave continuous surface, upon which the user stands while performing the motions. In embodiments the surface has a radius about the distance from a base of a user's foot to the user's hip joint. The concave surface of the platform may be a low friction, fixed surface, firm enough to support a user's weight without substantial deformation. In embodiments the surface reduces the friction of a user's feet contacting the surface of the platform sufficiently to allow omni-directional motion.

All of U.S. Pat. No. 7,470,218 teaching, and in particular the summary above, may be incorporated here and used in combination with the present invention.

The simulated walk taught by U.S. Pat. No. 7,470,218 entails sliding of a user's feet in opposite directions typically forward and backward, such that the net effect is to move legs back and forth as in walking. The user does not move from the starting position, but remains within the said low friction dish.

Of particular importance to a sliding simulation of walking is a low coefficient of friction (COF) because high COF makes a user more tired. The present invention may be advantageously used in combination with the teaching of U.S. Pat. No. 7,470,218.

### SUMMARY OF THE INVENTION

According to the present invention there is provided a polymer friction surface subject to sliding contact with footware worn by a user wherein said friction surface is embossed and said footware having hard, gloss interface with said friction surface.

In one embodiment of the present invention there is provided a polymer friction surface subject to sliding contact with footware worn by a user wherein said friction surface is embossed and said embossment infused with liquid and said footware having hard, gloss interface with said friction surface.

With no particular preference there is provided a friction surface wherein said embossment is of either negative or positive relief.

In one of several possible arrangements there is provided a friction surface wherein said embossment may have relief features of any shape taken from the group: square, rectangular, circular and ellipsoidal or any irregular shape and said shapes being arranged in a regular array or irregular pattern.

In one arrangement a friction surface is provided wherein said embossment is pinseal positive relief.

Preferably said friction surface is chosen from an engineering polymer, exemplified by the group: UHMWPE, ABS, high density polyethylene, polyamide, poly oxy methylene, polyethylene terephthalate, polymethyl-methacrylate, fluoro-polymers, polyvinylchloride.

Advantageously said embossed friction surface is infused with a liquid, said liquid being one or more from the group: Fluorocarbon oil, liquid soap, wax, silicone liquid, olefin liquid, anionic, cationic or non-ionic surfactants and the like.

In one arrangement said embossed friction surface is acted upon by a user wearing footware said footware having an interface with said embossed friction surface, said interface having a hard, gloss finish.

Advantageously said interface is provided by a plurality of pieces, said pieces being attached to said footware sole, said pieces having two major opposing faces and one or more minor face.

Preferably said pieces are from the group of materials: glass, glass ceramic, ceramic, glazed ceramic, porcelain, hard metal, hardened metal, enamelled steel, alumina, zirconia and the like.

More preferably said footware interface pieces are mosaic tiles, balls, cylpebs, domed hardened steel discs, and the like.

Most preferably said footware interface pieces are mosaic tiles of shape: square, hexagon, circular.

Advantageously said footware interface pieces are mosaic circular ceramic tiles.

Usefully said footware interface pieces, have hard gloss surface in contact with said friction surface said pieces with hard, gloss surface being disposed from toe to heel and orthogonal to this axis maintaining the same plane, so as to have the same or similar curvature of said friction surface.

More advantageously said hard, gloss surface having a rounded edge proximate to said friction surface.

In one arrangement said footware with plurality of interface pieces said pieces being attached to said sole after said footware sole is manufactured.

More preferably said footware has said interface pieces moulded in to said footware sole during said sole manufacture.

Advantageously said plurality of interface pieces is replaceable in said footware sole.

In one arrangement footwear wherein said footwear is primary interface between a user and said friction surface and is exemplified by trainers, walking shoes, sport shoes, slippers, indoor shoes and the like

In another arrangement footwear is an intermediate interface situated between footwear worn by a user and said friction surface and is exemplified by: overshoe, strap-on sole, clip-on sole and the like

Advantageously a friction surface and footware as described wherein said friction surface is the surface of an omnidirectional treadmill and said footware acts thereon.

### BRIEF DESCRIPTION OF DRAWINGS

The invention will be further described with reference to the following drawings:

FIG. 1 is a schematic drawing of friction surface and shoe interface

FIG. 2 is a schematic drawing of negative embossment

FIG. 3 is a schematic drawing of positive embossment

FIG. 4 is a schematic drawing of a liquid infused friction surface

FIG. 5 is a schematic drawing of a circular interface piece

FIG. 6 is a schematic drawing of disposition of interface pieces on footware

FIG. 7 is a schematic diagram of interface pieces interface plane with respect to friction surface

### DETAILED DESCRIPTION OF THE INVENTION

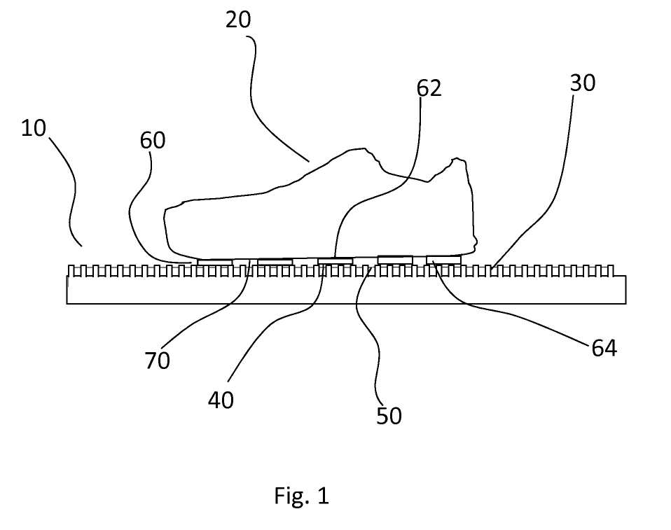

With reference to FIG. 1 there is provided a polymer friction surface 10 subject to sliding contact with footware 20 worn by a user wherein said friction surface 10 is embossed 30 and said footware 20 having hard, gloss interface 40 with said friction surface 10. This arrangement providing lower COF than for a non-embossed friction surface.

Again with reference to FIG. 1 there is provided a polymer friction surface 10 subject to sliding contact with footware 20 worn by a user wherein said friction surface 10 is embossed 30 and said embossment 30 is infused with liquid 50 and said footware 20 having hard, gloss interface 40 with said friction surface 10.

In another embodiment and again with reference to FIG. 1 there is provided a polymer friction surface 10 subject to sliding contact with footware 20 worn by a user wherein said friction surface 10 is embossed 30 and said friction surface 10 has applied there-to a dry lubricant (not shown) and said footware 20 having hard, gloss interface 40 with said friction surface 10.

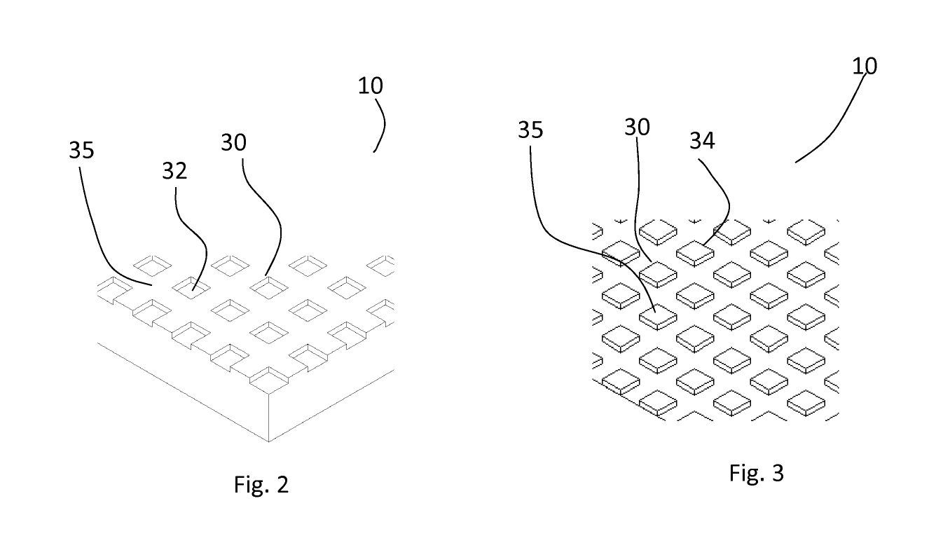

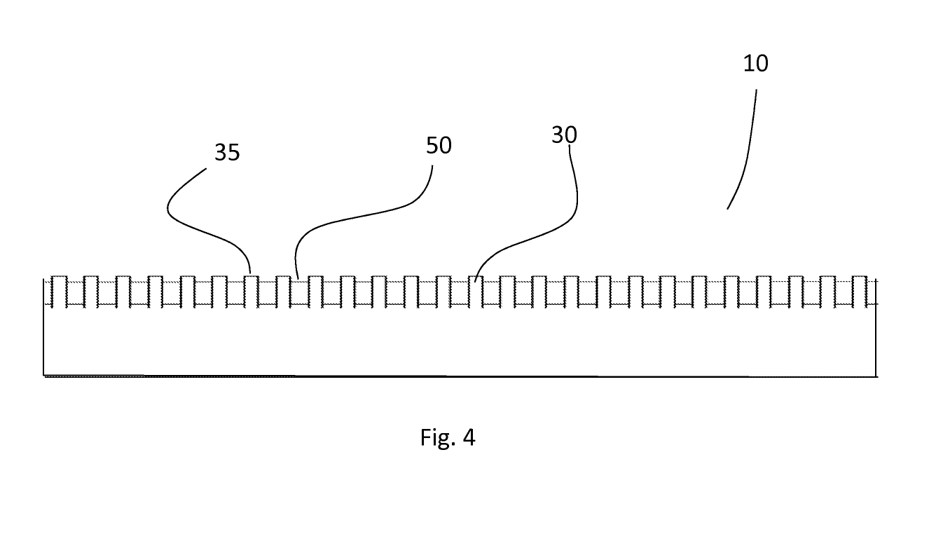

With reference to FIGS. 2 and 3 friction surface 10 with said embossment 30 is of either negative 32 or positive 34, relief.

Embossment 30 may have relief features of any shape e.g. square, rectangular, circular and ellipsoidal or any irregular shape and said shapes may be in regular or irregular pattern.

In one arrangement said embossment is pinseal positive relief.

Polymers to make friction surface 10 may be chosen from any engineering polymer, exemplified by UHMWPE, ABS, high density polyethylene, polyamide, poly oxy methylene, polyethylene terephthalate, polymethyl-methacrylate, polyvinylchloride.

With reference to FIG. 2 preferably the size of said embossment features 30 is small in comparison to hard, gloss interface 40 such that many embossment features 30 support said hard, gloss interface 40.

Advantageously there is provided a friction surface 10, reference to FIG. 4, wherein said surface is infused with a liquid 50, said liquid 50 being one or more from the group: Fluorocarbon oil, liquid soap, wax, silicone liquid, olefin liquid, anionic, cationic or non-ionic surfactants, e.g. household household detergent and the like.

Preferably liquid 50, with reference to FIGS. 2, 3 and 4, infused in said surface 10 should not breach above said embossment 30 and preferably upper most surface 35 of said friction surface 10 remains substantially dry to the touch. In one embodiment a dry lubricant (not shown), such as PTFE, is applied to friction surface 10 and similarly achieves a friction surface 10 which is substantially dry to the touch.

A surprising feature of the present invention is that whereas embossed surfaces are generally used to increase friction so as to prevent sliding, said friction surface 10 with said embossment 30 of the present invention when infused with one or more of said liquid 50, or a dry lubricant is applied to said friction surface the result in both instances substantially lowers friction when stood on by a user wearing footware 20 having an interface 40 with hard, gloss finish, interfacing with said friction surface 10.

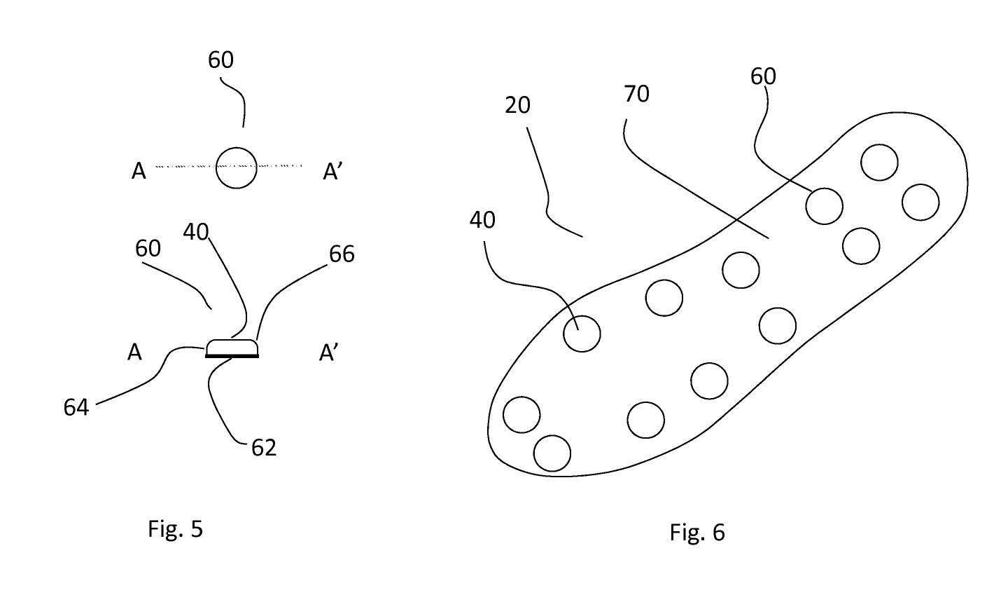

Advantageously footware 20 with interface 40 with reference to FIGS. 4 and 5, is provided by a plurality of pieces 60, said pieces 60 being attached to said footware sole 70, said pieces 60 having two major opposing faces 62, 40 and one or more minor face 64.

Advantageously footware 20 has attached pieces 60, said pieces being from the group of materials: glass, glass ceramic, ceramic, glazed ceramic, porcelain, hard metal, hardened metal, enamelled steel, alumina, zirconia and the like.

There is advantage in using hard materials with a gloss finish because said gloss finish is more resistant to scratching during normal use. Of particular advantage is fully vitrified porcelain, Gorilla glass

More advantageously footware 20 has attached pieces 60, said pieces being mosaic tiles, balls, cylpebs, domed hardened steel discs, and the like.

With reference to FIGS. 5 and 6, preferably footware 20, with attached pieces 60 said pieces being mosaic tiles, exemplified, but not limited by the following shapes: square, hexagon, circular.

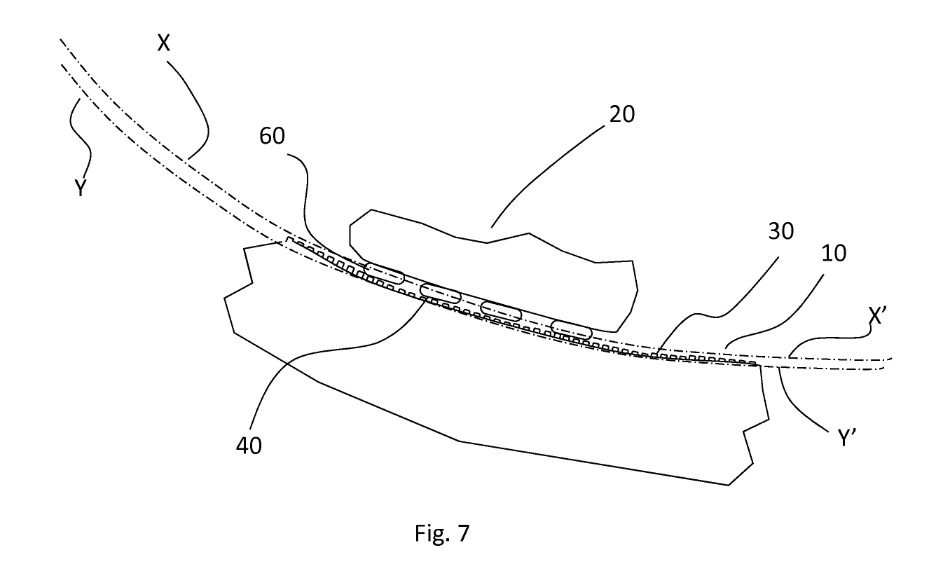

With reference to FIGS. 6 and 7 preferably pieces 60 are circular and yet more preferably having hard, gloss surface 40, said pieces with hard gloss surface 40 being attached to shoe sole 70, said pieces being disposed from toe to heel and orthogonal to this axis maintaining the same plane to said shoes sole surface 70 so as to present hard gloss surfaces 40 of said pieces 60 on a curvature X-X′ that is the same, similar or smaller curvature Y-Y′ of said friction surface 10.

Advantageously with reference to FIGS. 5 and 6 said hard, gloss surface 40 having rounded edge 66 proximate to said friction surface 10.

In one arrangement, with reference to FIG. 6, footware 20 has said plurality of interface pieces 60 attached to said sole 70 by adhesive bonding said adhesive bonding occurring after said footware sole 70 is manufactured.

More preferably in an alternate arrangement said interface pieces 60 are resin moulded in to said footware sole 70 during sole manufacture

In one arrangement footwear 20 wherein said footwear is primary interface between a user (not shown) and said friction surface 10 and is exemplified by trainers, walking shoes, sport shoes, slippers, indoor shoes and the like.

In another arrangement footwear 20 is an intermediate interface situated between footwear worn by a user and said friction surface 10 and is exemplified by: overshoe, strap-on sole, clip-on sole, sticky sole and the like.

Even more preferably to provide for the possibility of replacing damaged interface pieces 60, said footware 20 having plurality of interface pieces 60, said pieces being demountable i.e. replaceable in said footware sole 70.

In accordance with the present invention there is provided a low friction interface that may advantageously be used in constructing exercise equipment, omnidirectional treadmills and the like, said interface comprising; a low friction surface 10 with embossment 30 and infused liquid 50 in combination with interface pieces 60 having hard, gloss surface 40 disposed on footware 20.

The invention will be further illustrated by the following examples:

In example 1 a friction surface has been made from an acrylonitrile butadiene styrene (ABS) polymer with pinseal emboss pattern of positive relief. When said friction surface is infused consecutively with ˜1 ml/m² silicone oil, household detergent diluted with 10 cc water and then allowed to evaporate over 24 hours, fluorocarbon oil or liquid soap similarly diluted and dried as for detergent and a person of ˜100 kg mass stands on the liquid infused friction surface with trainers having twelve ceramic gloss tiles evenly distributed and bonded to the soles of each shoe with gloss surface facing towards said friction surface the COF is low <0.1. Said friction surface being thoroughly cleaned between each liquid infusion application.

In example 2 a friction surface has been made from a high density polyethylene (HDPE) polymer with pinseal emboss pattern of positive relief. When said friction surface is infused with ˜1 ml/m² silicone oil, household detergent diluted with 10 ml water and then allowed to evaporate over 24 hours, fluorocarbon oil or liquid soap similarly diluted and dried as for detergent and a person of ˜100 kg mass stands on the liquid infused friction surface with trainers prepared as for example 1 the COF is low <0.1. Said friction surface being thoroughly cleaned between each liquid infusion application.

In example 3 a friction surface has been made from an UHMWPE polymer with pinseal emboss pattern of negative relief. When said friction surface is infused with ˜1 ml/m² silicone oil, household detergent diluted with 10 ml water and then allowed to evaporate over 24 hours, fluorocarbon oil or liquid soap similarly diluted and dried as for detergent and a person of ˜100 kg stands on said liquid infused friction surface with trainers prepared as for example 1 the COF is low <0.1. Said friction surface being thoroughly cleaned between each liquid infusion application.

While various embodiments of the invention have been described the description is intended to be exemplary rather than limiting and it will be apparent to those of ordinary skill in the art that many more embodiments and implementations are possible that are within the scope of the invention. Accordingly the invention is not to be restricted except in the light of the attached claims supported by the description herein.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

1. A polymer friction surface subject to sliding contact with footwear worn by a user wherein said friction surface is embossed and said footwear having hard, gloss interface with said friction surface .

2. A polymer friction surface , as claimed in claim 1, subject to sliding contact with footwear worn by a user wherein said friction surface is embossed and said embossment is infused with liquid and said footwear having hard, gloss interface with said friction surface .

3. A polymer friction surface, as claimed in claim 1, wherein said friction surface has applied there-to a dry lubricant.

4. A friction surface subject to sliding contact with footwear worn by a user wherein said friction surface is embossed and said footwear having hard, gloss interface with said friction surface wherein said embossment is of either negative or positive relief.

5. A friction surface as claimed in claim 4 wherein said embossment may have relief features of any shape taken from the group: square, rectangular, circular and ellipsoidal or any irregular shape and said shapes being arranged in a regular array or irregular pattern.

6. A friction surface as claimed in claim 1, wherein said embossment is pinseal positive relief

7. A friction surface as claimed in claim 1 wherein said friction surface is an engineering polymer exemplified by the group: UHMWPE, ABS, high density polyethylene, polyamide, poly oxy methylene, polyethylene terephthalate, Fluoro-polymers, polymethyl-methacrylate, polyvinylchloride.

8. A friction surface as claimed in claim 7 wherein said surface is infused with a liquid, said liquid being one or more from the group: Fluorocarbon oil, liquid soap, wax, silicone liquid, olefin liquid, anionic, cationic or non-ionic surfactants.

9. A friction surface subject to sliding contact with footwear worn by a user wherein said friction surface is embossed and said footwear having hard, gloss interface with said friction surface said footwear having an interface with said friction surface, said interface having a hard and gloss finish

10. Footwear as claimed in claim 9 wherein said interface is provided by a plurality of pieces , said pieces being attached to the sole of said footwear , said pieces having two major opposing faces at least one of which has a gloss finish and said pieces having one or more minor face.

11. Footwear as claimed in claim 10 wherein said pieces are from the group of materials: glass, glass ceramic, ceramic, glazed ceramic, porcelain, hard metal, hardened metal, enamelled steel, alumina, zirconia and the like.

12. Footwear as claimed in claim 11 wherein said pieces are mosaic tiles, balls, cylpebs, domed hardened steel discs, and the like.

13. Footwear as claimed in claim 12, wherein said pieces are mosaic tiles of shape: square, hexagon, circular.

14. Footwear as claimed in claimed in claim 12, wherein said pieces are glazed porcelain circular tiles.

15. Footwear as claimed in claimed in claim 10, wherein said pieces , have hard, gloss surface in contact with friction surface said pieces with hard, gloss surface being disposed from toe to heel and orthogonal to this axis in the same plane as the sole of said footwear , so as to have the same or similar curvature of said friction surface.

16. Footwear as claimed in claimed in claim 15, wherein said pieces and said hard, gloss surface having a rounded edge proximate to said friction surface.

17. Footwear as claimed in claim 16 wherein said plurality of interface pieces are attached to said sole during or after said footwear sole is manufactured.

18. Footwear as claimed in claim 16 wherein said plurality of interface pieces are replaceable in said footwear sole.

19. Footwear as claimed in claim 10 wherein said footwear is an intermediate interface situated between footwear worn by a user and said friction surface and is exemplified by: overshoe, strap-on sole, clip-on sole, sticky sole and the like

20. A polymer friction surface subject to sliding contact with footwear worn by a user wherein said friction surface is embossed said embossment having either negative or positive relief and said embossment being lubricated and said footwear having an interface with said friction surface said interface having hard gloss finish, said interface comprising a plurality of pieces wherein said friction surface is the surface of an omnidirectional treadmill and said footwear acts thereon.
